(19) United States
(12) Patent Application Publication
(10) Pub. No.: US 2012/0314916 A1
(43) Pub. Date: Dec. 13, 2012

(54) IDENTIFYING AND TAGGING OBJECTS WITHIN A DIGITAL IMAGE

(75) Inventor: LEIGH M. ROTHSCHILD, SUNNY ISLES BEACH, FL (US)

(73) Assignee: REAGAN INVENTIONS, LLC, BAY HARBOUR, FL (US)

(21) Appl. No.: 13/495,498

(22) Filed: Jun. 13, 2012

Related U.S. Application Data
(60) Provisional application No. 61/496,162, filed on Jun. 13, 2011.

(51) Int. Cl. G06K 9/62

(52) U.S. Cl. 382/118; 382/115

(57) ABSTRACT

Identifying people in a digital image. An image of a plurality of persons is received. Image recognition is performed on the image to identify the plurality of persons. Upon an identifier for a particular one of the persons being recognized based upon the image recognition, a first tag associated with the particular one of the persons is applied to the image. Upon an identifier for a different one of the persons not being available based upon the image recognition, a user is prompted to enter the identifier for the different one of the persons. A second tag associated with the different one of the persons is applied to the image.

### CROSS-REFERENCE TO RELATED APPLICATIONS

The present application claims priority under the laws and rules of the United States, including 35 USC §120, to U.S. Provisional Patent Application No. 61/496,162 filed on Jun. 13, 2011. The contents of U.S. Provisional Patent Application No. 61/496,162 filed on Jun. 13, 2011 are herein incorporated by reference in their entirety.

### BACKGROUND

Billions of digital images are captured each year by digital imaging devices such as conventional digital cameras and more recently camera phones such as the iPhone, Android Devices, and the BlackBerry mobile devices. The captured images are normally transferred and stored in local storage devices (e.g. hard drives or flash memory, etc.) or remote storage sites such as Mobile Me (now called iCloud), Flixster, Picassa, etc. as well as social networking sites such as Twitter, Facebook, My Space, LinkedIn, etc.

Once the images are stored, users may subsequently query the storage database to retrieve and display the images on the user's local computing device (e.g. mobile device, mobile phone, tablet computer, laptop computer, desktop computer, etc.). Traditionally, the user may be able to retrieve the images by date, time, geographic location, and any user added notes (attached or associated with the images). Further, the current state of the art allows a user to add the names of individuals that are contained in an image (called tagging) to the image information file, but such manual addition is both cumbersome and time consuming. Thus, a need exists for the digital capture device to automatically “tag” or label the individuals that are in a digital image and then send the tagged images to the local or remote storage device for later retrieval.

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 is a block diagram illustrating a network for identifying objects in a captured digital image in accordance with one embodiment disclosed within this specification;

FIG. 2 is a block diagram illustrating a mobile device that is used to identify objects in a captured digital image in accordance with one embodiment disclosed within this specification;

FIG. 3 is block diagram of an exemplary remote device that may be used to identify objects in a captured digital image in accordance with one embodiment disclosed within this specification; and

FIGS. 4A and 4B are a flowchart presenting a method of identifying objects in a digital image in accordance with one embodiment disclosed within this specification.

FIGS. 5A and 5B are a flowchart presenting a method of identifying objects in a digital image in accordance with another embodiment disclosed within this specification.

### DETAILED DESCRIPTION

Embodiments of the present disclosure include systems, devices and methods of identifying objects, such as people, in a digital image. In the current state of the art, many people take digital photographs of their friends and family using a mobile device, such as a stand-alone digital camera, or a digital camera coupled to a mobile phone, tablet computer, mobile computer, or the like. In illustration, each friend or family member has and carries their own mobile phone that stores user identification information that includes a user image, user name, and associated information. Prior to capturing an image of friends and family, the digital photographer's mobile device may request, receive, and store such user identification information. Moreover, after capturing the digital image of friends and family, the image capturing mobile device processes the digital image and identifies the people in the image based on the requested, received, and stored user identification information.

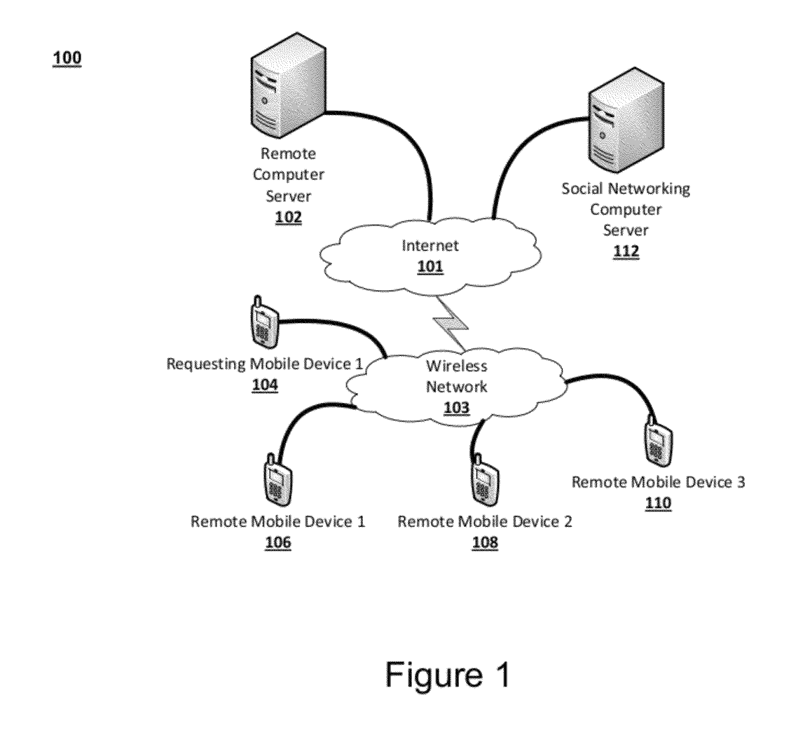

FIG. 1 is a block diagram illustrating a network 100 for identifying objects in a captured digital image in accordance with one embodiment disclosed within this specification. The network 100 includes a communication network 101 such as the Internet coupled to a wireless network 103. Further, the network of devices 100 includes a requesting mobile device 1 104, a remote mobile device 1 106, a remote mobile device 2 108, and a remote mobile device 3 110 coupled to the wireless network 103. In addition, remote computer server 102 and social networking computer server 112 are coupled to the communication network 101. Moreover, requesting mobile device 1 104, remote mobile device 1 106, remote mobile device 2 108, and remote mobile device 3 110 have access to remote computer server 102 and social networking computer server 112 through the wireless network 103 and communication network 101.

In an embodiment, the user of the requesting mobile device 1 104 prepares to capture a digital image or photograph of remote users of remote mobile device 1 106, remote mobile device 108, and remote mobile device 3 110. The remote users may be friends and family to the user of the requesting mobile device 1 104, all of which are attending an event (e.g. family wedding). Prior to capturing the digital image, the requesting mobile device, sends a query signal to one or more of the remote mobile devices(106, 108, 110). The query signal requests identification information of the remote user that may include an image of the remote user, name, or any other associated information.

Each remote mobile device (106, 108, 110) receives the query signal from the requesting mobile device (110) and processes the request. Further, one or more of the remote mobile devices (106, 108, 110) send a response to the query signal that includes an image of the remote user, name, or any other associated information. The requesting mobile device 104 receives the response from each of the one or more remote mobile devices (106, 108, 110) including an image of a remote user of a corresponding remote mobile device (106, 108, 110). In addition, the requesting mobile device 104 processes each response from each of the one or more remote mobile devices (106, 108, 110) including processing and storing the image of the remote user corresponding to each remote mobile device (106, 108, 110). Thereafter, the digital photographer may capture a digital image using the requesting mobile device. Alternative embodiments may include capturing the digital image and then sending the query signal requesting identification information. After, capturing the image, the requesting mobile device 1 106 identifies one or more objects, such as people, in the digital image using an image recognition software application based on the stored image of the remote user. Further, the image of the person is “tagged” or labeled by the image recognition software application.

However, there may be instances when certain objects such as people in the captured image are not able to be identified by the image recognition software application based on the stored images. This may be due to lack of clarity in the captured image or the application has no stored image of the person to compare with the captured image. Thus, the requesting mobile device 1 104 determines one or more unidentified objects in the digital image thereby presenting a query on the requesting mobile device to the digital photographer to identify the one or more unidentified objects. Subsequently, the digital photographer enters a response to the query through a user input device (e.g., touchscreen, keyboard, user interface, voice recognition, etc.). The requesting mobile device 1 104 receives a response to the query that identifies the one or more unidentified objects and “tags” or labels the captured image accordingly.

Further embodiments include transmitting the captured digital image including identification (e.g. tags, labels, etc.) of the one or more objects to the remote computer server 102. Subsequently, the requesting mobile device 1 104 (or any requesting computing device) may send a request for a stored image to the remote computer server 102, and the request includes identification information (e.g. tag, label, name of person, object, etc.) of an object in the stored image. The request is processed by the remote computer server 102 and determines the stored image based on the identification information of the object. The remote computer server 102 sends and the requesting mobile device 104 receives the stored image from the remote computer server 102 in response to the request.

Alternative embodiments include configuring the requesting mobile device 104, prior to capturing the digital image, to send the digital image to a social networking computer server 112 such that the captured digital image can be presented on a social networking site.

Additional embodiments include determining which remote mobile devices (106, 108, 110) to query with request for remote user identification information. For example, the digital photographer and the remote users may be attending a wedding reception with several hundred guests. However, the digital photographer would like to capture an image of remote users who are only in a ten feet radius of the requesting mobile device 104. Thus, the digital photographer configures the requesting mobile device 1 104 with a geographic area (e.g. 10 feet radius) thereby determining the one or more remote mobile devices (106, 108, 110) based on geographic area. The requesting mobile device 1 104 and the remote mobile devices (106, 108, 110) include location software and data that can be accessed to determine each other's location with respect to each other.

Persons of ordinary skill in the art understand that the requesting mobile device 1 104 and one or more remote mobiles devices (106, 108, 110) can be a mobile phone, tablet computer, laptop computer, notebook computer, global positioning system, or a combination thereof.

Further embodiments include capturing a digital image by requesting mobile device 1 104 and then identifying one or more objects, such as people, in the digital image using an image recognition application based images stored in a contact repository. For example, the contact repository may be the list of contacts in a mobile phone. The current state of the art allows mobile phone users to store images of their contacts in the mobile phone contacts repository. The image recognition application may access such stored images in the requesting mobile device 1 104 contacts repository and identify one or more objects in the captured image accordingly. In addition, a contact repository may be a user's social networking contacts stored in the social networking computer server. The current state of the art of social networking sites includes an image of each user contact. Thus, after capturing the digital image, the requesting mobile device 104 may send the captured image to the social networking computer server 112 and an image recognition software application implemented on the social networking computer server 112 may identify the people in the captured image based on the images stored in the contact repository.

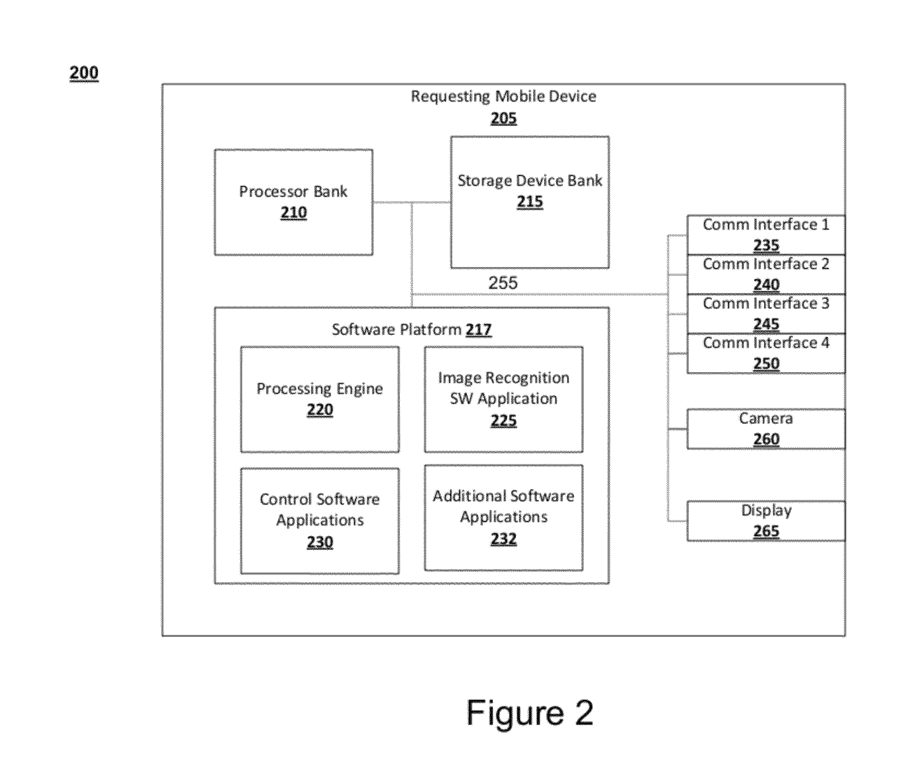

FIG. 2 is a block diagram 200 illustrating a mobile device 205 that is used to identify objects in a captured digital image in accordance with one embodiment disclosed within this specification. The requesting mobile device 205 includes, but is not limited to, a processor bank 210, a storage device bank 215, a software platform 217, one or more communication interfaces (235-250), a camera 260 and display 265.

The processor bank 210 may include one or more processors that may be co-located with each other or may be located in different parts of the requesting mobile device 205. The storage device bank 215 may include one or more storage devices. Types of storage devices may include memory devices, electronic memory, optical memory, internal storage media, and/or removable storage media. The one or more software applications 217 may include a processing engine 220, an image recognition software application 225, control software applications 230, and additional software applications 232. Further, the control and additional software applications 230 and 232 may include control software applications that implement software functions that assist in performing certain tasks for the requesting mobile device 205 such as providing access to a communication network, executing an operating system, managing software drivers for peripheral components, and processing information. In addition, the control and additional software applications 230 and 232 may also include software drivers for peripheral components, user interface computer programs, debugging and troubleshooting software tools. Also, the control and additional software applications 230 and 232 may include an operating system supported by the remote server. Such operating systems are known in the art for such a remote server but may also include computer and smartphone operating systems (e.g. Windows 7, Linux, Android, IOS UNIX, previous version of Windows and MacOS, etc.).

The processing engine 220 may send a query signal through one of the communication interfaces (235-250) to one or more remote mobile devices prior to capturing a digital image as described in FIG. 1. Such a query signal includes a request for remote user identification information such as a remote user image, name, or other associated information. Further, the requesting mobile device 205 may receive and the processing engine 220 may store such remote user identification information in the storage bank 215.

In addition, the requesting mobile device 205 captures a digital image using the camera 260 and stores the captured digital image in the storage bank 215. Moreover, the image recognition software application 225 compares the objects, such as people in the captured image to the images of the remote users stored in the storage bank 215, and identifies the people then tags or labels the captured image accordingly. If there are people the image recognition software application 225 cannot identify, the processing engine 220 is notified. The processing engine presents a query on the display 265 of the requesting mobile device 205 to identify the one or more unidentified objects (e.g. people). In response to the query, the user may enter the name or other identification information (e.g. Mr. Smith's wife) of the one or more unidentified objects. The processing engine 220 receives the response to the query and relays the identification information to the image recognition software application 225. Further, the image recognition software application 225 tags or labels the captured digital image accordingly. After objects in the captured digital image are identified (as much as possible), the digital image is transmitted including identification of its one or more objects to a remote computer server.

Subsequently, the requesting mobile device 205 using the processing engine 220 sends a request for a stored image to the remote computer server. The request includes identification information of an object in the stored image. The remote computer server identifies and retrieves the stored image based on the identification information of the object. Further, the remote server sends and the requesting mobile device 205 receives the stored image which is stored by the processing engine 220 in the storage bank 215.

In further embodiments, the user would like to configure a geographic area in which to send a query signal to remote mobile devices. The processing engine 220 may present such a geographic area query to the user on the display 265. The user may enter the desired geographic area (e.g. 10 feet) using an input device. The processing engine 220 receives the inputted geographic area and determines the remote mobile devices within the geographic area. The requesting mobile device 205 and the remote mobile devices include location software and data that can be accessed to determine each other's location with respect to each other.

In another embodiment, the processing engine 220 presents a query and receives user input to configure the requesting mobile device, prior to capturing the digital image, to send the digital image to a social networking computer server to be presented on a social networking site.

Each of the communication interfaces (235-250) shown in FIG. 2 may be software, firmware or hardware associated in communicating to other devices. The communication interfaces (235-250) may be of different types that include a user interface, USB, Ethernet, WiFi, WiMax, wireless, optical, cellular, or any other communication interface coupled to a communication network.

An intra-device communication link 255 between the processor bank 210, storage device bank 215, software platform 217, and communication interfaces (235-250) may be one of several types that include a bus or other communication mechanism.

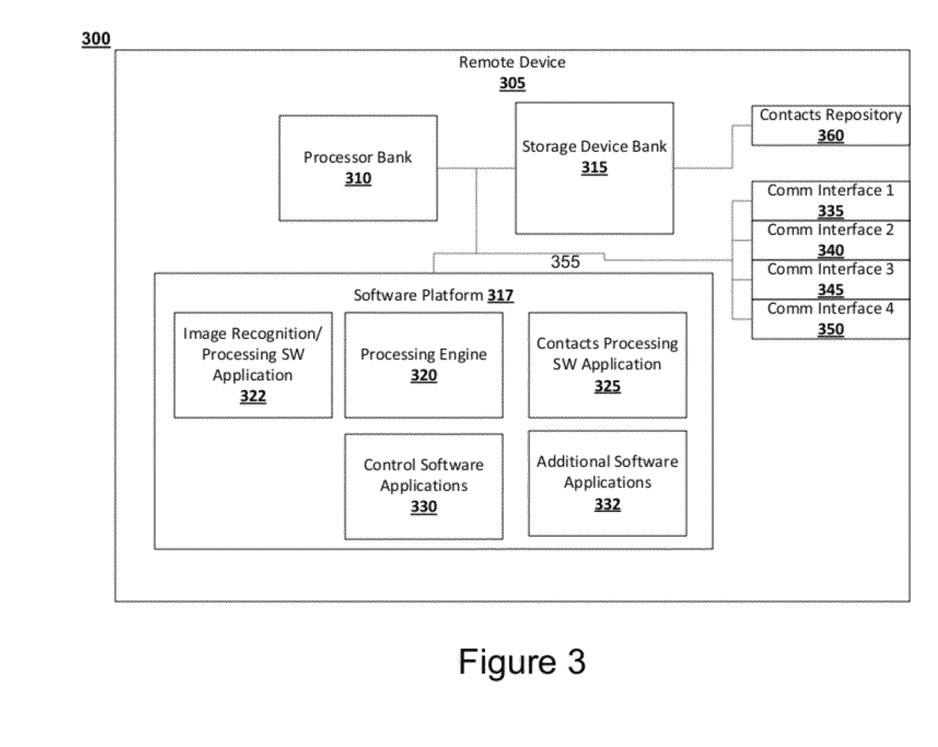

FIG. 3 is block diagram 300 of an exemplary remote device 305 that may be used to identify objects in a captured digital image in accordance with one embodiment disclosed within this specification. The remote device may be a remote mobile device or a social networking computer server as shown in FIG. 1. The remote device 305 includes, but is not limited to, a processor bank 310, a storage device bank 315, a software platform 317, one or more communication interfaces (335-350), and contacts repository 360 coupled to the storage bank 315.

The processor bank 310 may include one or more processors that may be co-located with each other or may be located in different parts of the requesting mobile device 305. The storage device bank 315 may include one or more storage devices. Types of storage devices may include memory devices, electronic memory, optical memory, internal storage media, and/or removable storage media. The one or more software applications 317 may include a processing engine 320, an image recognition software application 322, contact processing software application 325, control software applications 330, and additional software applications 332. Further, the control and additional software applications 330 and 332 may include control software applications that implement software functions that assist in performing certain tasks for the requesting mobile device 305 such as providing access to a communication network, executing an operating system, managing software drivers for peripheral components, and processing information. In addition, the control and additional software applications 330 and 332 may also include software drivers for peripheral components, user interface computer programs, debugging and troubleshooting software tools. Also, the control and additional software applications 330 and 332 may include an operating system supported by the remote server. Such operating systems are known in the art for such a remote server but may also include computer and smartphone operating systems (e.g. Windows 7, Linux, Android, IOS UNIX, previous version of Windows and MacOS, etc.).

The processing engine 320 may receive a query signal through one of the communication interfaces (335-350) from a requesting mobile device as described in FIGS. 1 and 2. Such a query signal includes a request for remote user identification information such as an image, name, or other associated information. Upon receipt, the processing engine 320 may forward the request to the contacts processing software application 325. Further, the contacts processing software application 325 may access the contacts repository to retrieve the user identification information of the remote device user. The user identification information may include an image, name, or other associated information. Once retrieved, the user identification information is sent to the requesting mobile device to be processed.

In an alternative embodiment, the remote device may be a social networking computer server. The contacts repository may include images of a social networking user's contacts In such an embodiment, the remote device 305 may receive a captured image from the requesting mobile device through the one or more communication interfaces (335-350). Upon receipt, the image recognition software application 322 compares the objects such as people in the captured image to the images stored in the contacts repository. If the image recognition software application 322 determines a match between a person in the captured digital image with an image of a contact stored in the contact repository, then the image recognition software application 322 tags or labels the captured image accordingly. Further, the remote device 305 sends the tagged or labeled captured image to the requesting mobile device. Alternatively, the remote device 305 may present the tagged or labeled captured image on the social networking site.

Each of the communication interfaces (335-350) shown in FIG. 3 may be software, firmware or hardware associated in communicating to other devices. The communication interfaces (335-350) may be of different types that include a user interface, USB, Ethernet, WiFi, WiMax, wireless, optical, cellular, or any other communication interface coupled to a communication network.

An intra-device communication link 355 between the processor bank 310, storage device bank 315, software platform 317, and communication interfaces (335-350) may be one of several types that include a bus or other communication mechanism.

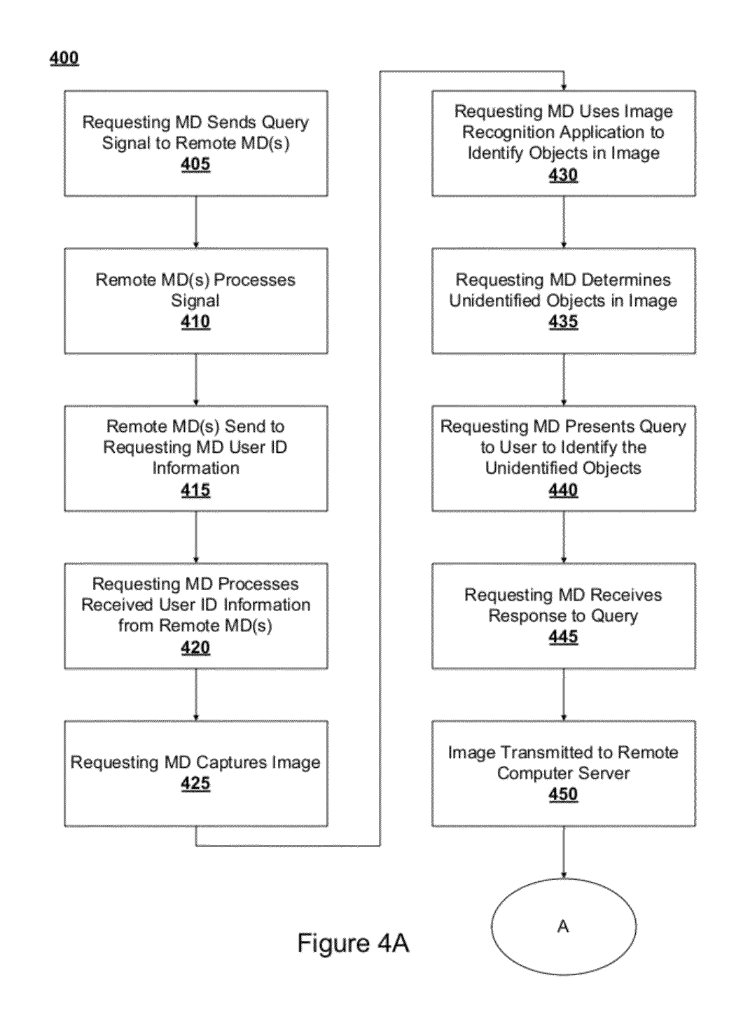

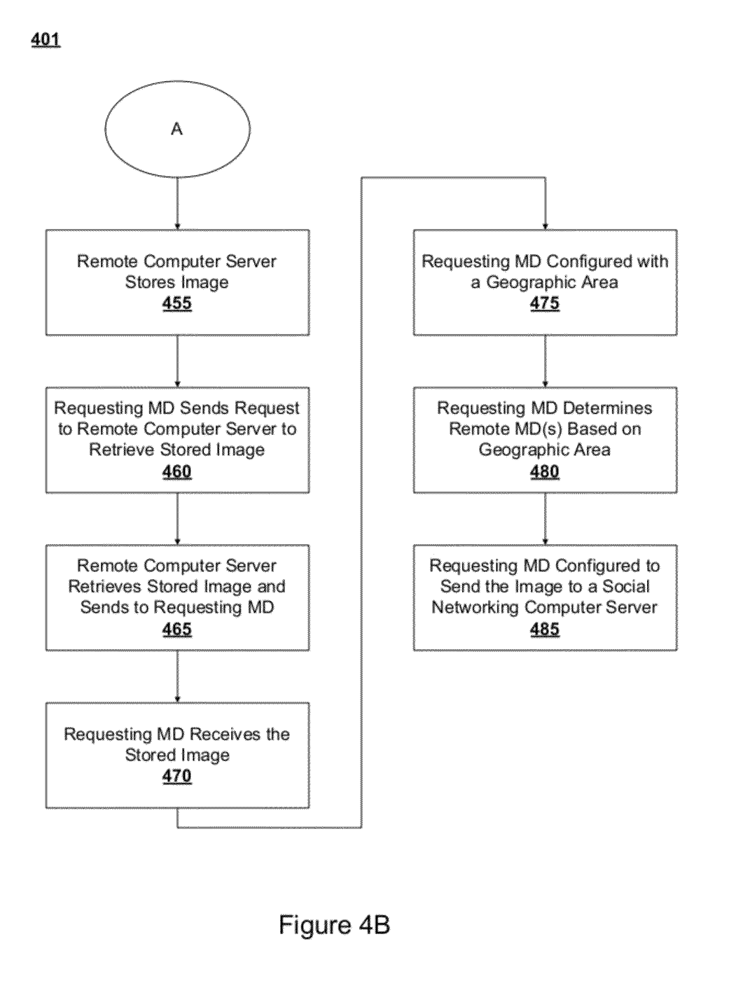

FIGS. 4A and 4B are a flowchart presenting a method (400 and 401) of identifying objects in a digital image in accordance with one embodiment disclosed within this specification. Referring to FIG. 4A, the method includes sending a query signal, by the requesting mobile device (MD), to one or more remote mobile devices, as shown in block 405. Further, the one or more remote mobile devices processes the query signal and elects to participate in the image capturing session, as shown in block 410. In addition, the one or more remote mobile devices sends the requesting mobile device the requested remote user identification information, as shown in block 415. Remote user identification information may include a remote user image, name, or other associated information.

The requesting mobile device receives, processes, and stores the remote user identification information, as shown in block 420. Moreover, the method includes the requesting mobile device capturing the digital image, as shown in block 425. Further, the method identifies one or more objects, such as people, in the captured digital image using an image recognition application based on the stored image of the remote user, as shown in block 430.

Further, the method includes the requesting mobile device determines one or more unidentified objects, such as people, in the captured digital image, as shown in block 435. In addition, the requesting mobile device presents a query on the requesting mobile device to identify the one or more unidentified objects, as shown in block 440. In response, the user may enter object identification information using an input device (e.g. touchscreen, keyboard, voice recognition, etc.). The requesting mobile device receives a response to the query that identifies the one or more unidentified objects, as shown in block 445.

The method further includes transmitting the digital image including identification of the one or more objects to the remote computer server, as shown in block 450. Referring to FIG. 4B, the remote computer server stores the image, as shown in block 455. Moreover, the requesting mobile device sends a request to the remote computer server to retrieve the stored image based on the identification of the object(s) in the stored image, as shown in block 460. Further, the method includes the remote computer server retrieving and sending the stored image to the requesting mobile device, as shown in block 465. In addition, the requesting mobile device receives the stored image, as shown in block 470.

In addition, the method includes the requesting mobile device being configured with a geographic area, as shown in block 475. For example, the digital photographer and the remote users may be attending a wedding reception with several hundred guests. However, the digital photographer would like to capture an image of remote users who are only in a ten feet radius of the requesting mobile device. Thus, the digital photographer configures the requesting mobile device with a geographic area (e.g. 10 feet radius). Moreover, the requesting mobile device determines the one or more remote mobile devices based on configured geographic area, as shown in block 480. The requesting mobile device and the remote mobile devices include location software and data that can be accessed to determine each other's location with respect to each other.

Further, the method includes configuring the requesting mobile device, prior to capturing the digital image, to send the digital image to a social networking computer server to be presented on a social networking site, as shown in block 485.

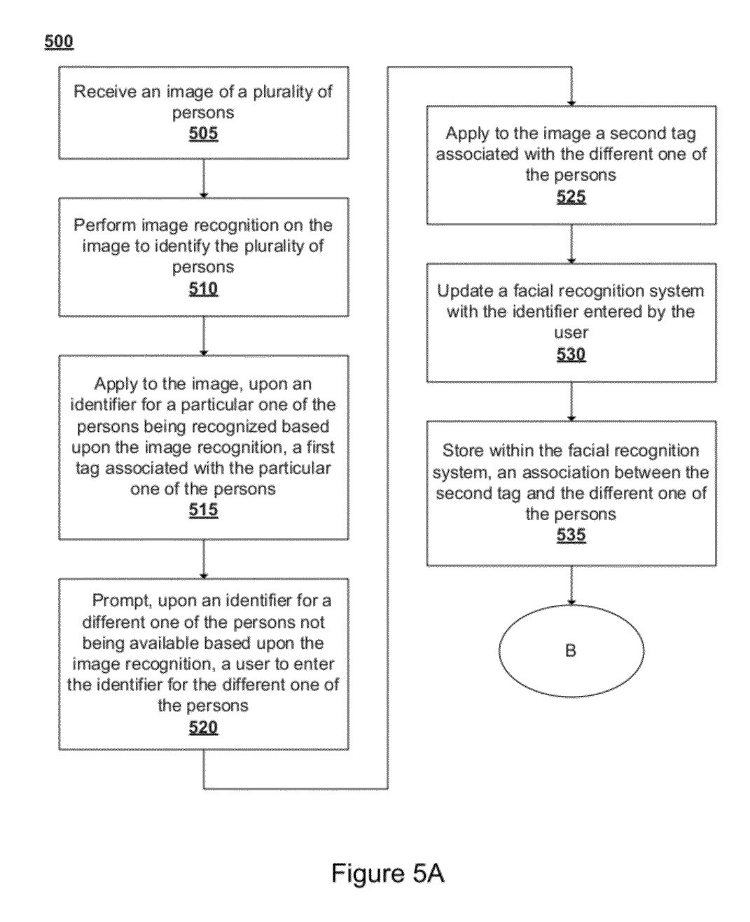

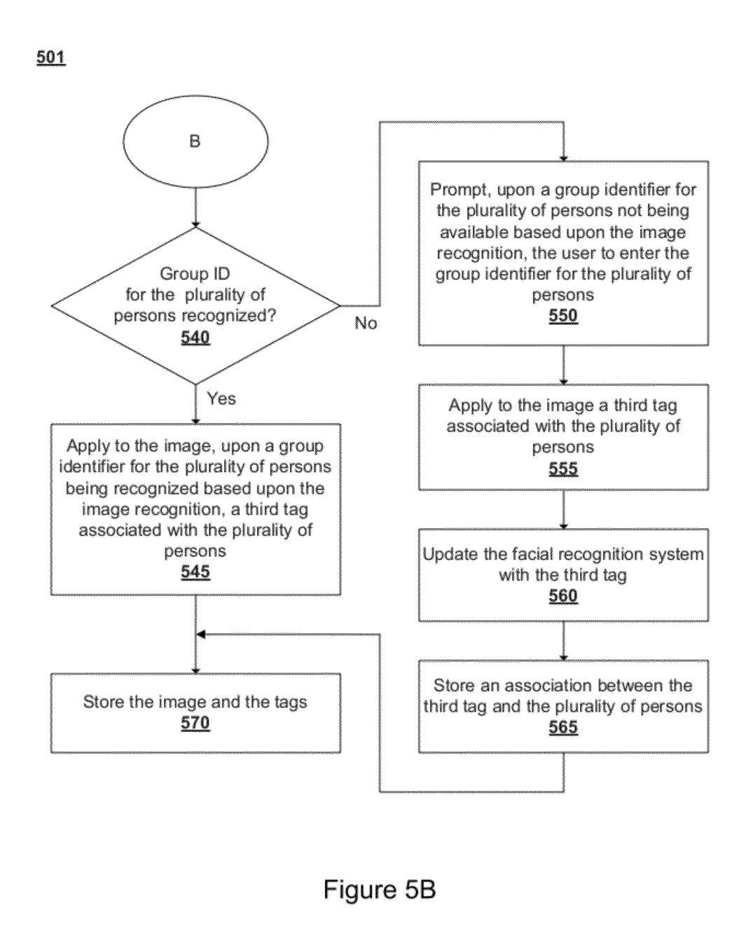

FIGS. 5A and 5B are a flowchart presenting a method (500 and 501) of identifying objects, such as people, in a digital image in accordance with another embodiment disclosed within this specification. As shown in block 505, an image of a plurality of persons is received. In one arrangement, the image can be captured on a mobile device (e.g., a mobile computer, a tablet computer, a mobile station, a mobile telephone, a personal digital assistant, or the like) or a computer. In this regard, the mobile device or computer can include a camera, or otherwise can be coupled to a camera. In another arrangement, the image can be received from a remote device. For example, the image can be received from another mobile device, computer or external camera.

As shown in block 510, image recognition can be performed on the image to identify the plurality of persons. For example, facial recognition can be applied to the image. The image recognition can be performed on a local device, such as the mobile device or computer that received the image, or on a remote device to which the local device is communicatively linked, such as a suitable computer, a suitable server, or a node (e.g., processing node) of a social networking system or network cloud. In the case the image is received from a remote device, the remote device on which the image recognition is performed need not the same remote device from which the image is received. For example, the image can be received from a particular remote device, while the image processing can take place on another remote device to which the device receiving the image is communicatively linked.

As shown in block 515, a first tag associated with a particular one of the persons can be applied to the image upon an identifier for the particular person being recognized based upon the image recognition. Further, additional tags respectively associated with other persons can be applied to the image upon respective identifiers for such persons being recognized based upon the image recognition.

As shown in block 515, upon an identifier for a different one of the persons not being available based upon the image recognition, a user can be prompted to enter the identifier for the different one of the persons. Further, the user can be prompted to enter respective identifiers for other ones of the persons for which respective identifiers are not available based upon the image recognition. As shown in block 525, a second tag associated with the different one of the persons can be applied to the image. Further, additional tags associated with the other different ones of the persons can be applied to the image.

As shown in block 530, a facial recognition system can be updated with the identifier entered by the user. If the user enters additional identifiers for other different ones of the persons, the facial recognition also can be updated with such identifiers. As shown in block 535, an association between the second tag and the different one of the persons can be stored within the facial recognition system. Further, associations between respective tags and the identifiers entered by the user for other different ones of the persons can be stored within the facial recognition system. Accordingly, when other images of the different persons are received, the user need not re-enter the identifiers in order for respective tags to be applied to such other images.

As shown in decision block 540, a determination can be made as to whether a group identifier for the plurality of persons is recognized based upon the image recognition. If so, as shown in block 545, upon a group identifier for the plurality of persons being recognized based upon the image recognition, a third tag associated with the plurality of persons can be applied to the image.

If a group identifier for the plurality of persons is not available based upon the image recognition, however, as shown in block 550, the user can be prompted to enter the group identifier for the plurality of persons. As shown in block 555, a third tag associated with the plurality of persons can be applied to the image. As shown in block 560, the facial recognition system can be updated with the third tag. As shown in block 565, an association between the third tag and the plurality of persons can be stored within the facial recognition system.

As shown in block 570, the image and the tags can be stored. The image and tags can be stored on a local device, such as the mobile device or computer, or on the remote device. For example, the image and tags can be stored to a node (e.g., a storage node) of a social networking system or network cloud. Regardless of where the image is stored, the image can be stored to a suitable computer-readable storage medium.

The foregoing is illustrative only and is not intended to be in any way limiting. Reference is made to the accompanying drawings, which form a part hereof. In the drawings, similar symbols typically identify similar components, unless context dictates otherwise.

The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

Further, the present invention may be embodied as a computer program product comprising a computer-readable storage medium having stored thereon program code that, when executed, configures a processor to perform executable operations related to the functions and/or processes described herein. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium is any tangible storage medium that can contain, or store, a program for use by or in connection with an instruction execution system, apparatus, or device.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. A method of identifying people in a digital image, comprising:
receiving an image of a plurality of persons;
performing, via a processor, image recognition on the image to identify the plurality of persons;
applying to the image, upon an identifier for a particular one of the persons being recognized based upon the image recognition, a first tag associated with the particular one of the persons;
prompting, upon an identifier for a different one of the persons not being available based upon the image recognition, a user to enter the identifier for the different one of the persons;
applying to the image a second tag associated with the different one of the persons.

2. The method of claim 1, further comprising:
updating a facial recognition system with the second tag; and
storing, within the facial recognition system, an association between the second tag and the different one of the persons.

3. The method of claim 1, further comprising:
applying to the image, upon a group identifier for the plurality of persons being recognized based upon the image recognition, a third tag associated with the plurality of persons.

4. The method of claim 1, further comprising:
prompting, upon a group identifier for the plurality of persons not being available based upon the image recognition, the user to enter the group identifier for the plurality of persons;
applying to the image a third tag associated with the plurality of persons.

5. The method of claim 4, further comprising:
updating a facial recognition system with the third tag; and
storing, within the facial recognition system, an association between the third tag and the plurality of persons.

6. The method of claim 1, wherein the performing the image recognition comprises performing the image recognition on a mobile device.

7. The method of claim 6, wherein receiving the image includes capturing the image on the mobile device.

8. The method of claim 6, wherein receiving the image includes receiving the image from a remote device.

9. The method of claim 6, further comprising:
storing the image and the first and second tags on the mobile device.

10. The method of claim 6, further comprising:
storing the image and the first and second tags on a remote device.

11. The method of claim 10, wherein the remote device is a node of a social networking system.

12. The method of claim 1, wherein performing the image recognition comprises performing the image recognition on a remote device.

13. The method of claim 12, wherein the remote device is a node of a social networking system.

14. A device comprising:
a processor configured to initiate executable operations comprising:
receiving an image of a plurality of persons;
performing, via a processor, image recognition on the image to identify the plurality of persons;
applying to the image, upon an identifier for a particular one of the persons being recognized based upon the image recognition, a first tag associated with the particular one of the persons;
prompting, upon an identifier for a different one of the persons not being available based upon the image recognition, a user to enter the identifier for the different one of the persons;
applying to the image a second tag associated with the different one of the persons.

15. The device of claim 14, wherein the processor further is configured to initiate executable operations comprising:
updating a facial recognition system with the second tag; and
storing, within the facial recognition system, an association between the second tag and the different one of the persons.

16. The device of claim 14, wherein the processor further is configured to initiate executable operations comprising:
applying to the image, upon a group identifier for the plurality of persons being recognized based upon the image recognition, a third tag associated with the plurality of persons.

17. The device of claim 14, wherein the processor further is configured to initiate executable operations comprising:
prompting, upon a group identifier for the plurality of persons not being available based upon the image recognition, the user to enter the group identifier for the plurality of persons;
applying to the image a third tag associated with the plurality of persons.

18. The device of claim 17, wherein the processor further is configured to initiate executable operations comprising:
updating a facial recognition system with the third tag; and
storing, within the facial recognition system, an association between the third tag and the plurality of persons.

19. The device of claim 14, wherein the performing the image recognition comprises performing the image recognition on a mobile device.

20. The device of claim 19, wherein receiving the image includes capturing the image on the mobile device.

21. The device of claim 19, wherein receiving the image includes receiving the image from a remote device.

22. The device of claim 19, wherein the processor further is configured to initiate executable operations comprising:
storing the image and the first and second tags on the mobile device.

23. The device of claim 19, wherein the processor further is configured to initiate executable operations comprising:
storing the image and the first and second tags on a remote device.

24. The device of claim 23, wherein the remote device is a node of a social networking system.

25. The device of claim 14, wherein performing the image recognition comprises performing the image recognition on a remote device.

26. The device of claim 25, wherein the remote device is a node of a social networking system.

27. A computer program product for identifying people in a digital image, said computer program product comprising:
a computer-readable storage medium having stored thereon program code that, when executed, configures a processor to perform executable operations comprising:
receiving an image of a plurality of persons;
performing, via a processor, image recognition on the image to identify the plurality of persons;
applying to the image, upon an identifier for a particular one of the persons being recognized based upon the image recognition, a first tag associated with the particular one of the persons;
prompting, upon an identifier for a different one of the persons not being available based upon the image recognition, a user to enter the identifier for the different one of the persons;
applying to the image a second tag associated with the different one of the persons.

28. The computer program product of claim 27, the executable operations further comprising:
updating a facial recognition system with the second tag; and
storing, within the facial recognition system, an association between the second tag and the different one of the persons.

29. The computer program product of claim 27, the executable operations further comprising:
applying to the image, upon a group identifier for the plurality of persons being recognized based upon the image recognition, a third tag associated with the plurality of persons.

30. The computer program product of claim 27, the executable operations further comprising:
prompting, upon a group identifier for the plurality of persons not being available based upon the image recognition, the user to enter the group identifier for the plurality of persons;
applying to the image a third tag associated with the plurality of persons.
